(19) United States
(12) Patent Application Publication
(10) Pub. No.: US 2012/0203592 A1
(43) Pub. Date: Aug. 9, 2012

(54) METHODS, APPARATUS, AND ARTICLES OF MANUFACTURE TO DETERMINE SEARCH ENGINE MARKET SHARE

(76) Inventor: Balaji Ravindran, New York, NY (US)

(21) Appl. No.: 13/023,160

(22) Filed: Feb. 8, 2011

(51) Int. Cl. G06Q 10/00; G06Q 30/00

(52) U.S. Cl. 705/7.29

(57) ABSTRACT

Methods, apparatus, and articles of manufacture to determine search engine market share are disclosed. A disclosed example method includes determining a first number of search results that were selected by a user and a second number of search results that were selected by the user, wherein the first number of search results is associated with searches performed via a first search engine and the second number of search results is associated with searches performed via a second search engine, and determining a first market share for the first search engine based on the first number and the second number of search results selected by the user.

### FIELD OF THE DISCLOSURE

This disclosure relates generally to Internet measurement, and, more particularly, to methods, apparatus, and articles of manufacture to determine search engine market share.

### BACKGROUND

Web search engines such as Google, Bing, and Yahoo provide users with the ability to search the Internet (e.g., the World Wide Web) using, for example, keywords. Many search engine companies generate revenue by advertising and often present searchers with topic-relevant advertisements. Search engine entities that are supported by advertising are in competition with each other to attract searchers. Higher numbers of searches increase revenues from advertisements by presenting more advertisements and/or attracting more advertisers and, thus, enabling higher per ad fees. Search engine entities have traditionally provided advertisers with volume metrics identifying a number of searches conducted in a time period to entice advertisers to buy advertisement space on the search engine site.

### BRIEF DESCRIPTION OF THE DRAWINGS

FIG. 1 is a schematic diagram of an example system to determine search engine market shares.

FIG. 2 is a block diagram of an example implementation of the monitor illustrated in FIG. 1.

FIG. 3 is a block diagram of an example implementation of the data processing facility illustrated in FIG. 1.

FIG. 4 is a table including example search interaction information that may be collected by the example monitor of FIG. 2.

FIG. 5 is a table including example search engine market shares that may be determined by the example system of FIG. 3.

FIG. 6 is a flowchart representative of example machine readable instructions which may be executed to generate search interaction information.

FIG. 7 is a flowchart representative of example machine readable instructions which may be executed to determine search engine market share.

FIG. 8 is a block diagram of an example computer capable of executing the instructions of FIGS. 6 and 7 to implement the apparatus of FIGS. 1-3.

### DETAILED DESCRIPTION

Currently, search engine market share is determined by the volume of searches that are performed on a respective search engine as a percentage of the total number of searches performed (e.g., the number of searches performed on Engine A divided by the number of searches performed on Engine A, Engine B, . . . , Engine N). Example methods, apparatus, and articles of manufacture disclosed herein determine a market share of a search engine based on the search value provided by the search engine to searchers (e.g., computer users).

As used herein, search value is a measure of the value provided to searchers by a particular search engine, as determined by the number of search results provided by a search engine that are selected by searchers, regardless of the number of searches performed. In some examples, the search value is also determined by a number of useful results selected by searchers, where backtracks from selected search results and the time spent on selected search results are considered in determining whether a selected search result is useful. In this way, the value provided by a search engine is considered to be higher when, for example, a user selects a search result generated by the search engine and then ends the search. In some examples, ending the search after selecting a search result indicates that the user found value in the selected search result. In some examples, a monitor on a computer collects search interaction information including identifications of search engine(s) on which searches are performed, a number of searches on each of the search engine(s), a number of search results selected by a searcher as a result of performing searches on each search engine, a number of backtracks for each search engine, and/or the time spent by the searcher at each selected search result for each search engine.

In some examples, the search interaction information is provided to a data processing facility or system. Search interaction information, as used herein, refers to any data or information indicative of how a user interacts with a search engine and/or with web pages resulting from interaction with a search engine. Example search interaction information includes identification(s) of search engine(s) on which searches are performed, number(s) (e.g., counts) of searches on each search engine, keywords and/or connectors (e.g., AND, OR, NOT, etc.) used in searches performed on each search engine, number(s) (e.g., counts) of selected search results resulting from searches performed on each search engine, number(s) (e.g., counts) of backtracks for each search engine, time(s) spent by searchers at each selected search result for each search engine, and/or average time(s) spent by searchers at selected search results for each search engines.

The example data processing facility aggregates search interaction information from multiple searchers and/or computers and determines search engine market share based on the aggregated search interaction information. In some examples, the search engine market share is determined based on a number of search results selected by (as opposed to searches performed by) searchers as a percentage of a total number of search results selected. In some examples, the search engine market share is based on the search results and the total number of search results, where both the search results and the total number of search results are adjusted based on numbers of backtracks by users. The search engine market share generated by disclosed example methods, apparatus, and articles of manufacture is referred to as a “search value market share” and/or a “value share,” and reflects the value that the respective search engine provides to searchers. In some examples, the data processing facility is provided by a neutral and/or trusted third party such as The Nielsen Company.

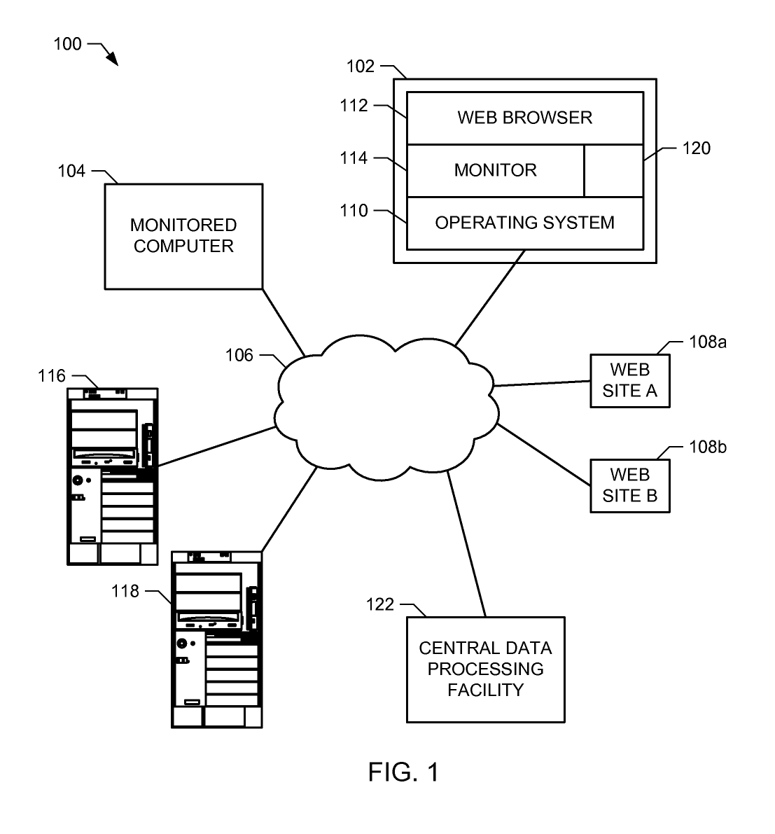

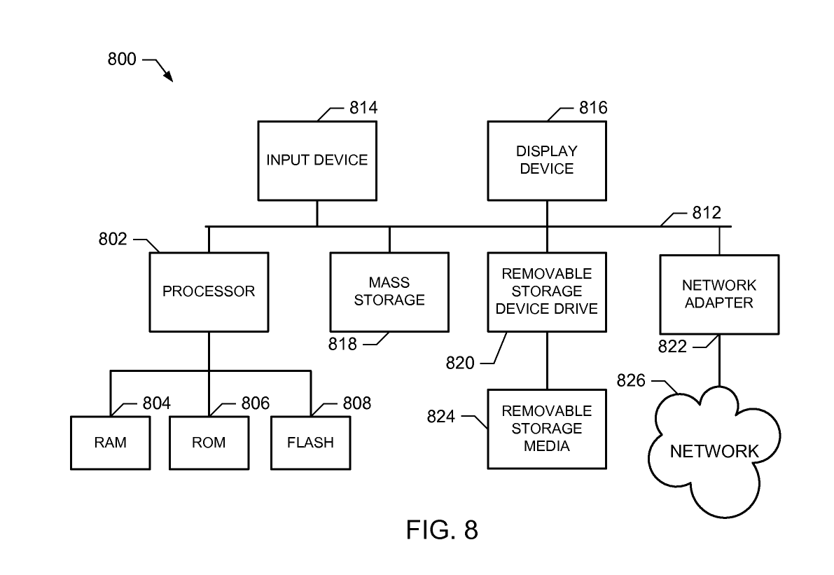

FIG. 1 is a schematic diagram of an example system 100 to determine search engine market share. The illustrated system 100 of FIG. 1 includes a plurality of computers 102, 104 capable of accessing a network 106 (e.g., the Internet). As described in more detail below, the computers 102, 104 may be included in an audience measurement panel to measure search engine market share. In the illustrated example of FIG. 1, the computers 102, 104 are general-purpose personal computers that may be used to access different web sites (e.g., web site A and web site B) 108a-108b, perform searches, exchange data, etc. The example computers 102, 104 may be implemented using the example computer 800 described below in conjunction with FIG. 8.

The example computer 102 of FIG. 1 includes an operating system 110 to manage the system resources of the computer 102. A user of the computer 102 (e.g., a panelist) interacts with applications executed by the computer 102, such as a web browser 112, to send and receive information via the network 106. The web browser 112 of the illustrated example interacts with the operating system 110 to access the network 106. The network 106 may be, for example the Internet. To measure the activities of a user on the computer 102 (e.g., media consumed on the computer 102, web sites visited on the computer 102, web searches performed on the computer 102, etc.), the example computer 102 of FIG. 1 also includes a monitor 114. The monitor 114 may be implemented as a layer (e.g., an application, a proxy, a wrapper, etc.) between the web browser 112 and the operating system 110 to transparently and/or non-transparently monitor interactions with the web browser 112, the information sent to and/or received from the network 106, operating system calls, input device movements and/or selections, keystrokes, and/or other communications that are indicative of user activities that may be monitored to measure computer use.

In the example of FIG. 1, search engines 116, 118 are communicatively coupled to the network 106 (e.g., the Internet). Each search engine 116, 118 of the illustrated example develops and maintains a search index of the web sites 108a-108b. The computers 102, 104 selectively access the search engine(s) 116, 118 via the network 106 to perform searches (e.g., keyword searches). On receiving a search request from a computer 102, 104, the example search engine 116, 118 develops a listing of search results corresponding to keywords and/or search connectors (e.g., AND, OR, NOT, etc.) in the search request, and returns the listing of search results to the requesting computer 102, 104. In the example of FIG. 1, search results are provided in a format that may be interpreted and rendered by the web browser 112 for viewing by a user (e.g., the requester). Web page document formats may include Hypertext Markup Language (HTML), JavaScript, Extensible Markup Language (XML), Cascading Style Sheets (CSS), and/or other web document formats. The search engine 116, 118 of the illustrated example may use any search engine algorithm(s) to develop a set of search results from a search query. Example search engines include Google™, Bing™, and Yahoo™.

The example monitor 114 of FIG. 1 identifies the search request transmitted from the browser 112 and/or the search results received at the browser 112. When the monitor 114 of the illustrated example identifies the search request and/or the search results, the monitor 114 counts the search in association with an identification of the search engine 116, 118 used to execute the search in a monitor storage 120. As used herein, storing a search count refers to storing a numerical and/or other count that records a number of searches that have been performed (e.g., in a time period). To count a search, the example monitor 114 increments the search count (e.g., increases the search count by 1) when a search is performed. Upon viewing the listing of search results (e.g., in the browser 112), the user may select a search result and navigate to the corresponding web site (e.g., the web site 108a). The monitor 114 of the illustrated example identifies the selection of the search result (e.g., via obtaining, capturing, and/or snooping a Hypertext Transfer Protocol (HTTP) request generated by the browser 112 when the user selects a search result) and counts the selection in the monitor storage 120 in association with the identification of the search engine 116, 118 that provided the search results. While the user views the selected web site, the monitor 114 of FIG. 1 determines an amount of time spent on the selected web site (e.g., the web site 108a) and stores the time in the monitor storage 120 in association with the identification of the search engine 116, 118 that provided the search results. For example, the monitor 114 may determine an amount of time the browser 112 is the active window and/or an amount of time the user interacts with the browser 112 (e.g., scrolls, mouses over objects, plays media, etc.). Techniques for monitoring user interaction with web pages are disclosed in Blumenau, U.S. Pat. No. 6,108,637 and Coffey, U.S. Pat. No. 5,675,510, both of which are hereby incorporated herein by reference. In some examples, the time spent at a selected search result may be indicative of whether the user found value in the selected result.

After the user explores the selected web site (e.g., web site 108a), the user may determine that the web site (e.g., web site 108a) either satisfies her query or does not satisfy her query. If the web site (e.g., web site 108a) satisfies the query, the user may pursue other tasks via the browser 112 and/or close the browser 112. The monitor 114 identifies the user's action and determines that the search has been completed. Any further searching actions taken by the user (e.g., entering a new search) are considered to be a new search. In the illustrated example, the monitor 114 does not count further navigation by the user from a selected search result (e.g., requesting another web page linked by a search result web page) because the further navigation is not considered to be a selection of a search result. In some examples, however, the monitor 114 counts further navigation from a search result as selections by the user if the navigation is considered to be value added by the search engine 116, 118 that returned the search results.

On the other hand, if the web site (e.g., web site 108a) does not satisfy the query, the user may either backtrack (e.g., click the “back” button in the browser 112 to return to the search results) or abandon the search (e.g., pursue other activities on the computer 102, close the browser 112, navigate to another web page not within the search results, open a different search engine and start a search, etc.). When the user backtracks, the monitor 114 of the illustrated example identifies the backtrack and increments a backtrack count in the monitor storage 120 in association with an identification of the search engine 116, 118. If the user selects another search result (e.g., the web site B 108b), the example monitor 114 of FIG. 1 detects the selection and increments the selections count in the monitor storage 120 in associated with the identification of the search engine 116, 118 and/or an identification of the search performed. An identification of the search performed may be a unique alphanumeric character string, a timestamp, one or more keywords used in the search or any combination thereof. Identifying searches in this manner provides more granular data to facilitate calculations like numbers of views per search, numbers of backtracks per search, etc. The above process repeats if the user continues to browse results and/or backtrack.

Periodically or aperiodically, the example monitor 114 of FIG. 1 reports the data (referred to herein as search interaction information) stored in the monitor storage 120 to a central data processing facility 122 via the network 106. For example, the monitor 114 illustrated in FIG. 1 reports a number of searches performed at the computer 102 per search engine 116, 118; a number of search result selections at the computer 102 per search engine 116, 118; a number of backtracks at the computer 102 per search engine 116, 118; and/or time spent at each search result at the computer 102 per search engine 116, 118. The reported search interaction information may be reported in association with specific searches and/or as an aggregation. The example central data processing facility 122 of FIG. 1 also receives similar search interaction information from other monitors coupled to the network 106. Collectively, the search interaction information from the monitors (including the monitor 114) is aggregated at the central facility 122 to form panel measurement data that quantifies the search values that the search engines 116, 118 provide to users. Panelists are selected to be generally reflective of a population whose computer and/or online habits are of interest. Panelists may be selected and/or recruited in any desired manner. In some examples, they are statistically selected to represent a specific population. The panelists may be required to provide demographic information data (e.g., gender, race, religion, income, education level, etc.) to facilitate correlating detected behaviors to demographic populations.

The example central data processing facility 122 of FIG. 1 determines a search value market share for each of the search engine(s) 116 or 118 in the aggregated data. In some examples, the central data processing facility 122 determines the market share for a search engine 116 or 118 using the aggregated search result selections for the search engine in question as a percentage of the total aggregated search result selections for the search engines 116, 118. An example search value market share is described below with reference to FIG. 5.

The example central data processing facility 122 of FIG. 1 provides the search value market share to clients and/or subscribers, such as investors, search engine companies, advertisers, users, and/or any other parties who are interested in the search value that search engines provide to users. In some examples, the central data processing facility 122 provides the search value market share in addition to other types of market share (e.g., search volume market share).

Although two monitored computer 102, 104, two web sites 108a, 108b, two search engines 116, 118, one network 106, and one central facility 122 are shown in FIG. 1, the system 100 may include any number of these elements (e.g., fewer or more than those shown in FIG. 1).

In an example of monitoring a user interaction with the search engine 116 from the computer 102, a user opens the web browser 112 using the operating system 110. The monitor 114 identifies that the web browser 112 was opened and stores the action (e.g., in the monitor storage 120). To perform a search, the user navigates to a search engine web site (e.g., Google, Bing, etc.) using the browser 112. The monitor 114 also identifies and stores the navigation action and the identity of the search engine by identifying the request from the browser 112 to the search engine 116 via the operating system 110. The user enters a desired search query into the search engine web page via the browser 112 and submits the search query to the search engine 116. In some examples, the browser 112 includes a feature that allows a user to search a designated search engine without first navigating to the search engine web site (e.g., by using a search bar provided by the web browser 112). The example monitor 114 of FIG. 1 identifies and stores the search query (e.g., in the monitor storage 120), including the keywords that define the query, by monitoring the request from the browser 112. For example, the monitor 114 may snoop (e.g., intercept, monitor keystrokes, etc.) and parse an HTTP request message to identify the search engine 116, 118 and/or the keywords of the search.

To enable parsing of HTTP requests, the example monitor 114 is provided with a model structure (e.g., a pattern) of a request for search engines that are to be monitored. For example, an HTTP request to search using Google includes at least: GET and HOST=www.google.com. After the GET term, the request includes a string of terms that, when performing a search on Google, includes at least the terms “q=” followed by the keywords of the search separated by plus (+) symbols. For example, a search using Google for the query “example search” can be observed in the HTTP request as “q=example+search.” While other terms may also be included in the HTTP request, the example monitor 114 identifies the search using Google based on the HOST=www.google.com term and the presence of the “q=” term in the request. Other search engines (e.g., Bing, Yahoo) use other HTTP request formats and the example monitor 114 uses other model structures to identify searches using these search engines.

Continuing with the example, the search engine 116 processes the search query and returns a listing of search results (e.g., in a web page). The example monitor 114 of FIG. 1 identifies the search results. For example, the monitor 114 may parse the HTML, JavaScript, and/or other code included in the web page provided by the search engine 116 to identify the web sites 108a-108b (e.g., the Internet protocol (IP) addresses) included in the search results as the search results are passed from the operating system 110 to the web browser 112. The individual search results included in the listing is used by the example monitor 114 to determine whether later requests for web sites 108a-108b correspond to the search request and/or the search results.

Continuing with the example, the user views the displayed search results and, in this example, selects a first search result of interest (e.g., web site 108a). The web browser 112 of the illustrated example generates an HTTP request and transmits the request to the web site 108a identified by the user selection. The selected web site generates an HTTP response based on the HTTP request. The HTTP response may include, for example, an HTML document that may be rendered by the web browser 112 to display information. The monitor 114 of the illustrated example receives and parses the HTTP request to the web site, determines whether the request corresponds to the search results (e.g., by comparing the IP address in the request to the IP addresses in the listing of search results to see if a match exists) and, in the event of a match, counts the selection (e.g., incrementing a selection count) for the search engine 116 that generated the search results in the monitor storage 120.

In this example, the user views and interacts with the requested web page for a time period. The monitor 114 of the illustrated example determines the amount of time the user interacts with the web page (e.g., by starting a timer when the request for the web page is selected and stopping the timer when a change of focus (e.g., backtracking, closing of the browser or the web page, etc.) is detected) and stores the measured length of the time period in the monitor storage 120 in association with the identification of the search and/or the identification of the search engine 116. The measured length of time may be used to determine whether the search result provided value to the searcher.

Continuing with the example, if the user decides that the web page does not provide the complete information that was the target of the search request, and clicks the “back” button on the browser 112. The browser 112 displays the listing of search results from which the user selected the search result web page. The monitor 114 of the illustrated example identifies and counts the backtrack event in the monitor storage 120 in association with the identification of the search and/or the identification of the search engine 116 associated with the search. In some examples, the monitor 114 does not count the backtrack if, for example, the monitor 114 determines that the user interacted with the web page long enough (e.g., longer than 30 seconds, 60 seconds, 90 seconds) to consider the user satisfied with the search result.

Continuing with the example, if the user selects another web page from the search results, the browser 112 generates another HTTP request (e.g., to the web site B 108b). The monitor 114 of the illustrated example identifies this HTTP request and the resulting response, and counts another selection for the search engine 116 in the monitor storage 120.

The user may perform additional searches using the same search engine 116 or a different search engine 118. The user may then select one or more web pages from the search result(s) of those additional searches. The monitor 114 of the illustrated example stores search interaction information in the monitor storage 120 based on the additional searches. At some later time, the monitor 114 of the illustrated example will determine that it is time to report the contents of the monitor storage 120 to the central data processing facility 122. The example monitor 114 then assembles and transmits the collected data via the network 106 to the central data processing facility 122. The example central data processing facility 122 of FIG. 1 receives the search interaction information from the monitor 114 and from additional computers (e.g., the computer 104), and aggregates the data. The central data processing facility 122 of the illustrated example determines the search value market share for the search engines 116, 118 based on the aggregated data and reports, publishes, and/or otherwise distributes the search value market share.

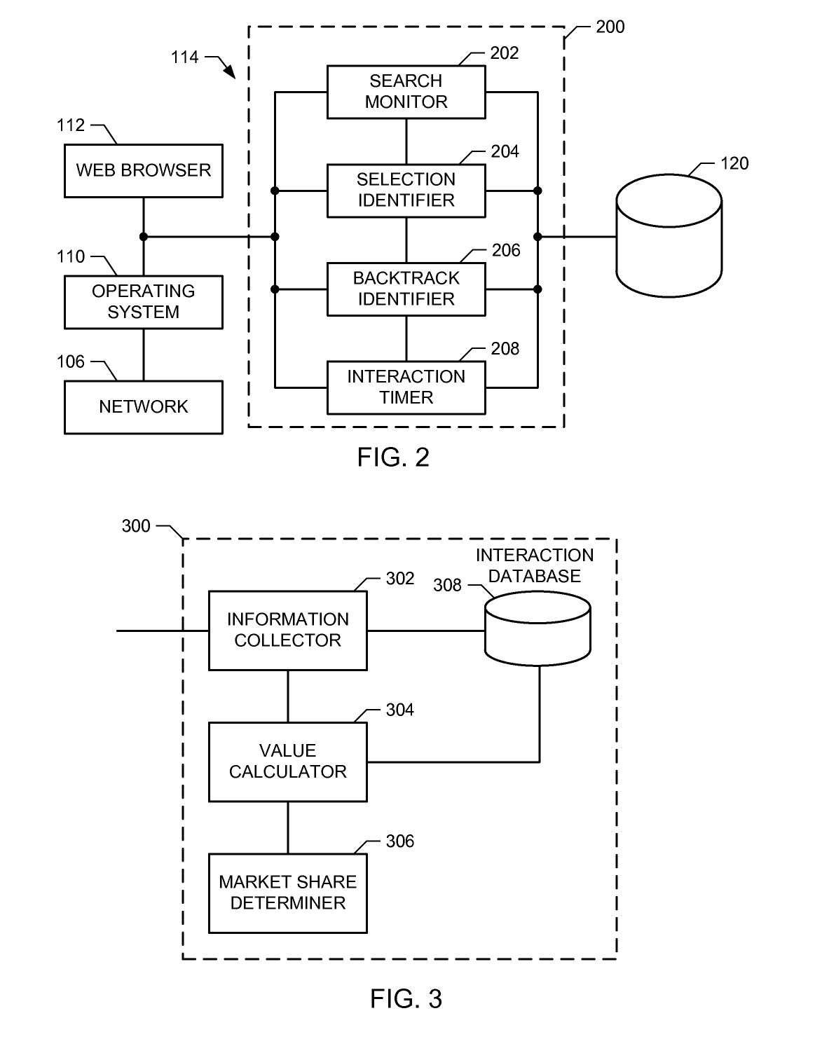

FIG. 2 is a block diagram of an example monitor 200 to implement the monitor 114 illustrated in FIG. 1. The monitor 200 illustrated in FIG. 2 includes a search monitor 202, a selection identifier 204, a backtrack identifier 206, and an interaction timer 208. The example monitor 200 monitors exchanges of data and/or data requests between (1) a web browser (e.g., the web browser 112 of FIG. 1) and/or other applications, and (2) an operating system (e.g., the operating system 110 of FIG. 1) to gather data about a user's activities on a computer (e.g., the computer 102 of FIG. 1). In the illustrated example of FIG. 2, each of the search monitor 202, the selection identifier 204, the backtrack identifier 206, and/or the interaction timer 208 receives and/or processes the data exchanges and/or requests between the operating system 110 and the web browser 112. However, in some other examples the monitor 200 is implemented as a layer that intercepts data exchanges between the operating system 110 and the web browser 112, processes the data, and forwards the data to the intended receiver (e.g., the operating system 110 or the web browser 112).

The example search monitor 202 receives data sent from the web browser 112 to the operating system 110 (e.g., search requests to the example search engine 116 of FIG. 1) and from the operating system 110 to the web browser 112 (e.g., HTML listings of search results from the search engine 116). The search monitor 202 is capable of parsing the information in the search request (e.g., an HTTP request) to extract the search query (e.g., the keywords in the search query). The search monitor 202 is also capable of parsing the response from the search engine (e.g., an HTTP response, an HTML file and/or a Java or JavaScript payload) to determine which web sites (e.g., the web sites 108a-108b of FIG. 1) have been included in the listing of search results. Based on the response, the example search monitor 202 stores the search results for later comparison and/or logs an impression for each of the web sites 108a-108b included in the search results. In some examples, the example search monitor 202 distinguishes the paid advertisement links (also known as sponsored links or sites) from organic search results. For example, the search monitor 202 may distinguish ads from search results by identifying a portion in a web page displaying the search results (e.g., by parsing HTML code) that includes advertisements and/or search results. For example, the Google and Bing engines identify advertisements, sponsored sites, and/or search results in the HTML documents that include the search results.

The example selection identifier 204 monitors data and/or requests transferred between the operating system 110 and the web browser 112. For example, the selection identifier 204 of FIG. 2 monitors in response to receiving an indication from the search monitor 202 that search results were received by the web browser 112. The selection identifier 204 monitors to determine whether the user has selected a search result (e.g., a hyperlink) from a listing of search results.

The selection of a search result by a user causes the web browser 112 to request a web site (e.g., to issue an HTTP request). The selection identifier 204 identifies and parses the request to determine the requested web site. Because the web browser 112 generates HTTP requests for different activities by the user, the example selection identifier 204 compares the requested web site (e.g., determined from the HTTP request) to the listing of search results stored by the search monitor 202. If the address of the requested web site parsed from an HTTP request by the selection identifier 204 is in the listing of search results, the selection identifier 204 determines that the user selected the requested web site from the listing of search results, and counts the selection in the monitor storage 120 in association with an identification of the search and/or an identification of the search engine that provided the search results. On the other hand, if the requested web site is not in the listing of search results, the example selection identifier 204 determines that the user entered the URL of another web site and did not make a selection from the listing of search results (e.g., the user abandoned the search).

Backtracks may be indicative of a user's satisfaction or dissatisfaction with a selected search result and, thus, the resulting value provided to the user by the search engine 116, 118 of FIG. 1. The example backtrack identifier 206 monitors the web browser 112 to identify when a user backtracks from a selected search result (e.g., a web page associated with a web site 108a-108b) to the listing of search results. For example, the backtrack identifier 206 may monitor for requests, commands, and/or responses between the web browser 112, the operating system 110, and/or the search engines 116, 118.

Previously visited web pages (e.g., a web page listing search results) may be stored in memory (e.g., cached) by the browser 112 for ease of return. Thus, to identify a backtrack, the backtrack identifier 206 of the illustrated example monitors for requests by the browser 112 to the operating system 110 for data from a memory. Additionally or alternatively, the backtrack identifier 206 of the illustrated example determines characteristics of the listing of search results (e.g., a web page signature) as the listing of search results is shown in the browser 112, and then monitors to determine whether the listing (e.g., the signature) reappears in the browser 112 (as indicated by the presence or re-presentation of the noted characteristics) after a search result selection has been identified. Other methods of identifying a backtrack may also be used.

The example interaction timer 208 monitors an amount of time that a user interacts with a search result web page. For example, when the selection identifier 204 identifies that a user has selected a search result from a listing of search results, the interaction timer 208 begins timing the user's interaction with the search result. When the user is finished interacting with the search result (e.g., the user backtracks, abandons the search, etc.), the illustrated interaction timer 208 stores the interaction time in the monitor storage 120. If, for example, the backtrack identifier 206 identifies a backtrack, the interaction timer 208 also provides the interaction time to the backtrack identifier 206, which uses the interaction time to identify whether to count the backtrack.

The interaction time may be affected by user activities, such as making another application window and/or web page window active instead of the search result, obscuring the web browser 112, and/or otherwise acting in a manner that suggests that the user is not interacting with the search result. For example, if the user interacts with the search result in the web browser 112, then opens another window in the web browser 112 (e.g., a word processing document), and then returns to the search result, the interaction timer 208 may not count the time that the user has interacted with the other window. Techniques to determine whether a window is occluded (and, thus, whether the window should be counted as active during a time period) are disclosed in U.S. Pat. No. 6,108,637.

Upon identifying a backtrack, the example backtrack identifier 206 of FIG. 2 receives the interaction time from the interaction timer 208. The example backtrack identifier 206 compares the interaction time to a threshold (e.g., 60 seconds, 90 seconds, 120 seconds) to determine whether the search result has satisfied the user. If the interaction time is higher than the threshold, the backtrack identifier 206 of the illustrated example assumes that the search result satisfied the user and does not count the backtrack. On the other hand, if the interaction time is less than the threshold, the backtrack identifier 206 counts a backtrack in the monitor storage 120.

While the illustrated example monitor 200 of FIG. 2 is shown as snooping (e.g., listening in parallel to) communications between the operating system 110 and the web browser 112, the example monitor 200 may additionally or alternatively intercept such communications. For example, the example monitor 200 could be implemented as a wrapper for the web browser 112, through which communications between the web browser 112 and the operating system 110 are directed and then forwarded to their respective destinations.

FIG. 3 is a block diagram of an example system 300 to implement the central data processing facility 122 illustrated in FIG. 1. The example system 300 of FIG. 3 includes an information collector 302, a value calculator 304, a market share determiner 306, and an interaction database 308. In general, the system 300 illustrated in FIG. 3 collects (e.g., receives) search interaction information, calculates the search value provided to searchers by each of multiple search engines (e.g., the search engines 116, 118 of FIG. 1), and determines a market share (e.g., a search value market share, a search volume market share, etc.) from the search values.

The example information collector 302 illustrated in FIG. 3 collects search interaction information to be used to calculate search engine market share (e.g., for the search engines 116, 118 of FIG. 1). Search interaction information refers to the data and/or information collected by monitors (e.g., the monitor 114) related to user interactions with web searches and search results. Example search interaction information collected by the information collector 302 is transmitted from the computers 102, 104 (e.g., monitor(s) 114 executing on the computers 102, 104) and includes identification(s) of search engine(s) (e.g., the search engines 116, 118) on which searches are performed, number(s) (e.g., counts) of searches on each search engine, keywords and/or connectors (e.g., AND, OR, NOT, etc.) used in searches performed on each search engine, number(s) (e.g., counts) of selected search results resulting from searches performed on each search engine, number(s) (e.g., counts) of backtracks for each search engine, time(s) spent by searchers at each selected search result for each search engine, and/or average time(s) spent by searchers at selected search results for each search engines. The information collector 302 aggregates the received search interaction information (e.g., from monitors on monitored computers 102, 104) and provides the aggregated search interaction information to the value calculator 304. In some examples, the information collector 302 additionally or alternatively stores the aggregated search interaction information in the interaction database 308, where it may be retrieved by the value calculator 304.

The example value calculator 304 of FIG. 3 receives the aggregated search interaction information from the information collector 302 (and/or retrieves the aggregated information from the interaction database 308) and calculates a search value for each of the search engines 116, 118. In some examples, the value calculator 304 calculates the search values (e.g., selections, selections less backtracks) at designated intervals (e.g., daily, weekly, monthly, yearly, etc.) to enable monitoring of trends in market share between different search engines 116, 118. To determine the search value of a search engine of interest (e.g., the search engine 116), the example value calculator 304 of FIG. 3 determines the number of selections of search results for the search engine 116 in the aggregated search interaction information (e.g., the selections count for monitored computers 102, 104 during a time period) for the search engine 116, and subtracts the number of backtracks (e.g., the backtracks count for monitored computers 102, 104 during the time period) for the search engine 116. In some examples, however, the value calculator 304 does not subtract the number of backtracks and the search values are then equal to the selection counts.

The example market share calculator 306 determines the search value market share for each of the search engines 116, 118. To determine the search value market share, the example market share calculator 306 receives the search values (e.g., selections, selections less backtracks) for the search engines and sums the search values to obtain a total search value. The example market share calculator 306 then determines the search value market share for each search engine using the search values as a percentage of the total search value. The example market share calculator 306 generates a report including the search value market share(s) for search engine(s) of interest. In some examples, the market share calculator 306 also determines other types of market share metrics and/or includes other types of metrics in the report.

If the value calculator 304 uses the backtracks to determine search values (e.g., the difference between the selections and backtracks) for each search engine 116, 118, the example market share calculator 306 also determines the total backtracks for the search engines 116, 118. The market share calculator 306 subtracts the total backtracks from the total selections to determine the total search value, and determines the search engine market shares for each search engine using the search value of the search engine as a percentage of the total search value. An example market share report is described below in conjunction with FIG. 5.

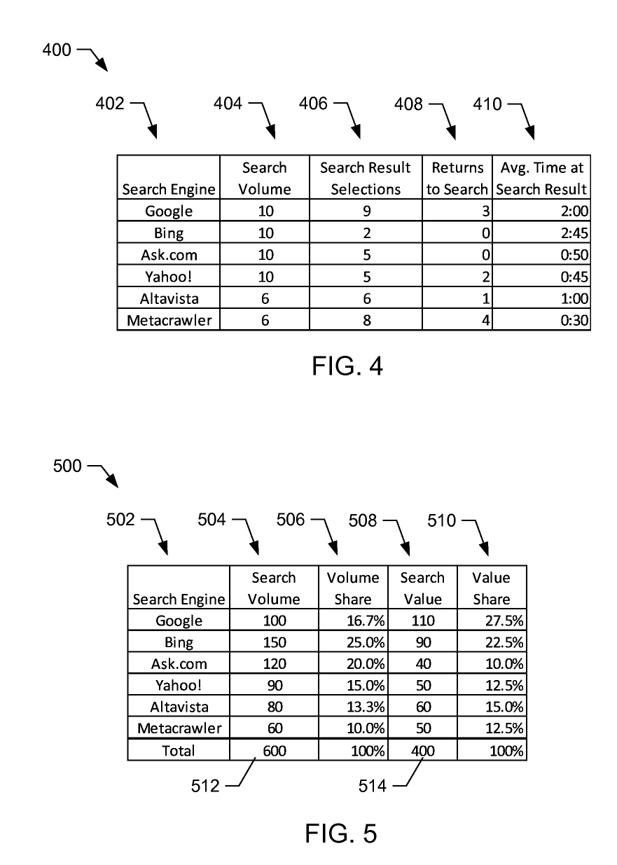

FIG. 4 shows a table 400 including example search interaction information that may be collected by the example monitor 200 of FIG. 2. The table 400 and/or the search interaction information may additionally or alternatively be used to implement the example interaction database 308 of FIG. 3. As illustrated in FIG. 4, the example table includes a search engine field 402, a search volume field 404, a search result selections field 406, a returns to search field 408 (referred to as the backtracks field 408 herein), and an average time at search result field 410. The following example will discuss the table 400 with reference to the example monitor 200.

The example search engine field 402 includes identifiers of the search engines (e.g., the search engines 116, 118 of FIG. 1) that were used by a user to perform web searches. The search engine field 402 may include names, websites, URLs, and/or any other proprietary or open identifier to individually identify search engines. In some examples, the search monitor 202 of FIG. 2 generates a new entry (e.g., row in the table 500) each time the user executes a search in a search engine 116, 118 that the user has not used to search within a particular reporting period. In some examples, entries for known search engines 116, 118 are populated in the table 400 and the monitor 200 provides data in the appropriate field(s) 404-410 to associate user search interactions with the corresponding search engine(s) 116, 118.

The example search volume field 404 includes counts of searches that have been performed for each search engine 116, 118 in the search engine field 402. The example search monitor 202 of FIG. 2 increments the search volume field 404 when a search request and/or search results are detected. The example search results selections field 406 includes counts of selections of search results by users in response to listings of search results. The example selection identifier 204 of FIG. 2 increments the corresponding search results selections field 406 when a user selects a search result from a listing of search results provided by a search engine 116, 118. The backtracks field 408 includes counts of backtracks from a selected search result to the listing of search results that provided the selected search result. The example backtrack identifier 206 of FIG. 2 increments the backtracks field 408 for the corresponding search engine 116, 118 when a backtrack is identified.

The example average time at search result field 410 includes an average of the time spent on a web page per selected search result. The example interaction timer 208 of FIG. 2 monitors the time that users spend interacting with selected search results, determines the average time spent on a search engine by search engine basis, and populates the average time at search result field 410 for the corresponding search engine 116, 118.

In the example illustrated in FIGS. 1-2, the table 400 is implemented in the example monitor storage 120 of FIG. 2 and the monitor 200 of FIG. 2 populates the example table 400. Additionally or alternatively, the table 400 may be populated and/or updated by the information collector 302 when the table 400 is implemented in the example interaction database 308 of FIG. 3. Other arrangements of the table 400 may be used, and/or data fields may be added, subtracted, and/or substituted from the table 400 to collect desired data.

FIG. 5 shows a table 500 including example search engine market shares that may be determined by the example central facility system 300 of FIG. 3. The table 500 may be generated by the example value calculator 304 and/or the example market share determiner 306 of FIG. 3 to report search engine market share(s) such as search value market share(s). As illustrated in FIG. 5, the example table 500 includes a search engine field 502, a search volume field 504, a volume share field 506, a search value field 508, and a value share field 510. The example table 500 will be described with reference to the example system 300 of FIG. 3 and the example table 400 of FIG. 4.

To generate the example table 500 of FIG. 5, the system 300 of FIG. 3 receives search interaction information, such as the information provided in the example table 400 of FIG. 4, from multiple sources. For example, the system 300 may receive tables similar or identical to the table 400 from computers (e.g., the computers 102, 104 via the monitor 114 of FIG. 1) associated with panelists who have agreed to participate in search engine measurements.

The search engine field 502 includes each of the search engines identified from the aggregated search interaction information. In some examples, the search engine field 502 includes only those search engines which have been used to perform a search by one or more panelists as identified in the search interaction information. In some examples, however, the search engine field 502 includes entries for each known search engine and/or for each search engine of interest irrespective of whether the panelists provide data for that particular engine. For example, some consumers or users of the information in the table 500 may request that only certain search engines be included in the table 500 for a particular study.

The search volume field 504 of the example of FIG. 5 includes the sums of the search volume fields 404 for the tables received from the monitored computers (e.g., the computers 102, 104 of FIG. 1). The example value calculator 304 of FIG. 3 sums the received search volumes and enters the total search volume for each of the example search engines in the search volume field 504. For example, the total search volume field 504 for Google includes the total number of searches performed on panelist computers 102, 104 using the Google search engine, according to the received search interaction information.

The volume share field 506 of the illustrated example includes the market shares for each of the example search engines in the search engine field 502 as determined by search volumes. To populate the volume share field, the example market share determiner 306 of FIG. 3 sums (totals) the search volume fields 504 into a total search volume 512, and determines the market share for each search engine using the respective search volume field 504 as a percentage of the total search volume 512. For example, the total search volume 512 in FIG. 5 is 600 searches, which is the sum of the search volumes performed on panelist computers 102, 104 using the search engines in the search engine field 504. The example volume share for Google is (100 searches)/(600 searches)=16.7%, and the example volume share for Bing is (150 searches)/(600 searches)=25.0%.

The search value field 508 of the illustrated example includes the search values for the tables received from panelist computers 102, 104 and/or monitors. In some examples, the search values 508 are equal to the sums of the search result selection fields 406 received from panelist computers 102, 104. In some other examples, the search values 508 are equal to the sums of the search result selection fields 406, less the sums of the backtrack fields 408, received from panelist computers 102, 104. The example value calculator 304 of FIG. 3 sums the received search result selections and enters the total search result selections for each of the example search engines in the search value field 508. For example, the search value field 508 for Google includes the total number of search result selections resulting from searches performed on panelist computers 102, 104 using the Google search engine, according to the aggregated search interaction information. In some examples, the search value field 508 may be reduced by a total number of backtracks resulting from searches performed using the respective search engines.

The value share field 510 of the illustrated example includes the market shares for each of the example search engines in the search engine field 502 as determined by search result selections. The example value share field 510 representative of the relative value(s) provided to searchers by each search engine. To determine value(s) for the value share field(s) 510, the example market share determiner 306 of FIG. 3 totals the search value fields 508 into total search value 514, and determines the market share for each search engine using the corresponding search value field 508 as a percentage of the total search value 514. For example, the example total search value 514 in FIG. 5 is 400, which is the sum of the selections performed on panelist computers 102, 104 using the search engines in the search engine field 504 (and, in this example, is not reduced by backtracks). The value share for Google is (110 selections)/(400 selections)=27.5%, and the value share for Bing is (100 selections)/(400 selections)=25.0%.

In the example of FIG. 5, Bing has a higher volume share than Google (e.g., more searches were performed using Bing than Google), but Google has a higher value share than Bing (e.g., more search results were selected from search results returned by Google than from search results returned by Bing). The higher value share for Google in this example implies that Google provides higher value to searchers because searchers select more search results from Google than from Bing. In some examples, the value share may be considered independently of the volume share and, thus, the volume share may be omitted from the example table 500. In some examples, however, the value share may be compared to the volume share and/or used with the volume share to determine additional metrics, such as a measure of selections per search (e.g., a search efficiency metric). The numbers in FIG. 5 are not taken from a study, but are provided for illustration and are not meant to accountably reflect the value shares of Google and Bing.

While example manners of implementing the monitor 114 and the central data processing facility 122 of FIG. 1 have been illustrated in FIGS. 2 and 3, one or more of the elements, processes and/or devices illustrated in FIGS. 2 and 3 may be combined, divided, re-arranged, omitted, eliminated and/or implemented in any other way. Further, the example computers 102, 104, the example monitor 114, the example central data processing facility 122, the example search monitor 202, the example selection identifier 204, the example backtrack identifier 206, the example interaction timer 208, the example information collector 302, the example value calculator 304, the example market share determiner 306, the example interaction database 308, and/or, more generally, the example monitor 200 and/or the example system of FIGS. 1, 2, and/or 3 may be implemented by hardware, software, firmware and/or any combination of hardware, software and/or firmware. Thus, for example, any of the example computers 102, 104, the example monitor 114, the example central data processing facility 122, the example search monitor 202, the example selection identifier 204, the example backtrack identifier 206, the example interaction timer 208, the example information collector 302, the example value calculator 304, the example market share determiner 306, the example interaction database 308, and/or, more generally, the example monitor 200 and/or the example system of FIGS. 1, 2, and/or 3 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended apparatus claims are read to cover a purely software and/or firmware implementation, at least one of the example search monitor 202, the example selection identifier 204, the example backtrack identifier 206, the example interaction timer 208, the example information collector 302, the example value calculator 304, the example market share determiner 306, the example interaction database 308, and/or, more generally, the example monitor 200 and/or the example system are hereby expressly defined to include a computer readable medium such as a memory, DVD, CD, etc. storing the software and/or firmware. Further still, the example monitor 200 and/or the example system of FIGS. 1, 2 and/or 3 may include one or more elements, processes and/or devices in addition to, or instead of, those illustrated in FIGS. 1, 2 and/or 3, and/or may include more than one of any or all of the illustrated elements, processes and devices.

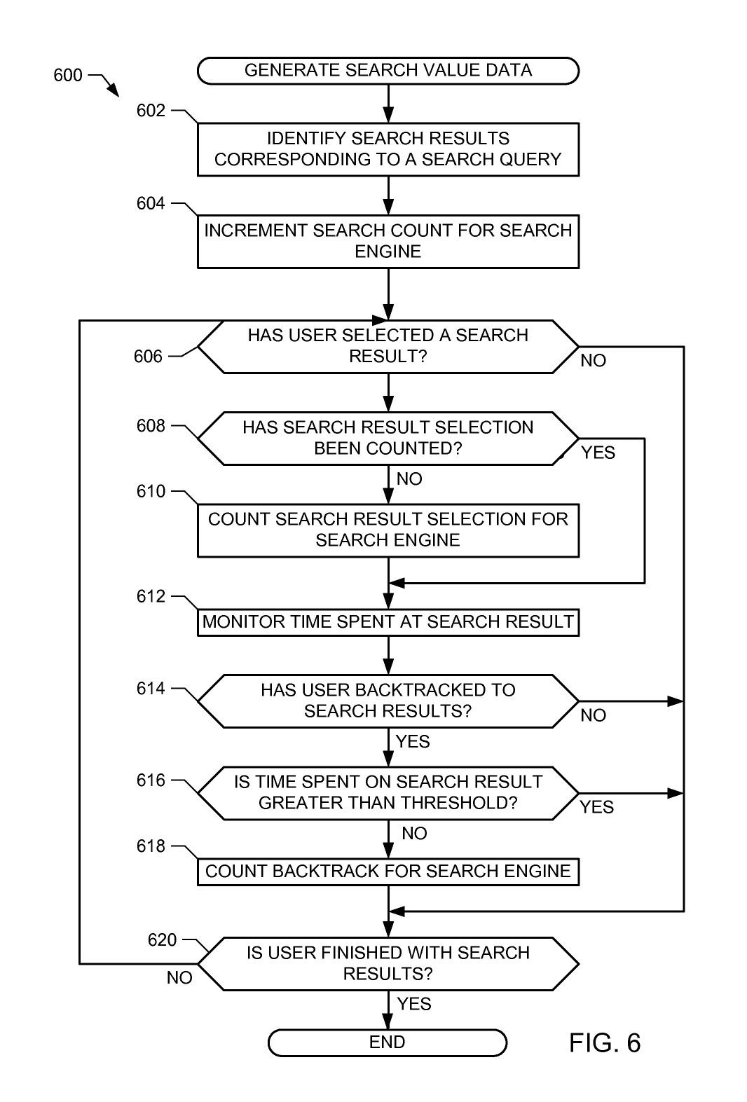

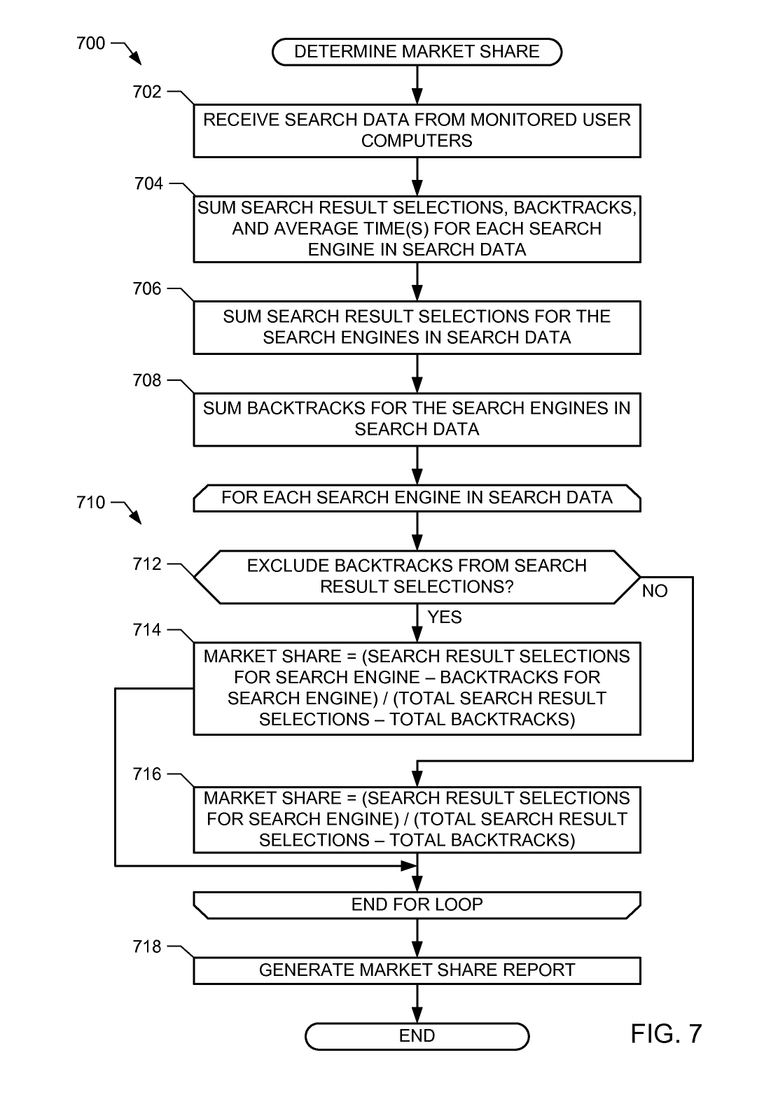

A flowchart representative of example machine readable instructions for implementing the monitor 200 of FIG. 2 is shown in FIG. 6. A flowchart representative of example machine readable instructions for implementing the system 300 of FIG. 3 is shown in FIG. 7. Together, the flowcharts of FIGS. 6 and 7 represent machine readable instructions that may implement the system of FIG. 1. In these examples, the machine readable instructions comprise respective programs for execution by one or more processors such as the processor 812 shown in the example computer 800 discussed below in connection with FIG. 8. The programs may be embodied in software stored on a computer readable medium such as a CD-ROM, a floppy disk, a hard drive, a digital versatile disk (DVD), or a memory associated with the processor 812, but the entire programs and/or parts thereof could alternatively be executed by a device other than the processor 812 and/or embodied in firmware or dedicated hardware. Further, although the example programs are described with reference to the flowcharts illustrated in FIGS. 6 and 7, many other methods of implementing the example monitor 200 and/or the example system 300 may alternatively be used. For example, the order of execution of the blocks may be changed, and/or some of the blocks described may be changed, eliminated, or combined.

As mentioned above, the example processes of FIGS. 6 and 7 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 6 and 7 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

FIG. 6 is a flowchart representative of example machine readable instructions 600 to generate search interaction information. The example instructions 600 may be used to implement the example monitor 200 of FIG. 2 to monitor a computer (e.g., the computer 102, 104 of FIG. 1). The instructions 600 will be discussed herein with reference to the example monitor 200 of FIG. 2 and the example table 400 of FIG. 4.

The example instructions 600 begin at block 602 with the search monitor 202 of FIG. 2 identifying search results corresponding to a search query. For example, the search monitor 202 may snoop a message (e.g., an HTTP response, an HTML document, etc.) and parse the message to determine a listing of search results sent to a web browser (e.g., the web browser 112 of FIG. 2) for display to a user. In particular, the search monitor 202 may identify web sites and/or the search engine (e.g., the search engine 116, 118 of FIG. 1) that generated the search results. The search monitor 202 then increments a search count for the determined search engine 116, 118 (e.g., in the monitor storage 120 of FIG. 2) (block 604). For example, the search monitor 202 may increment a search volume field (e.g., the search volume field 404 of FIG. 4) corresponding to the search engine that generated the search results (e.g., a search engine listed in the search engine field 402 of FIG. 4).

The selection identifier 204 then determines whether the user has selected a search result (block 606). The selection identifier 204 may identify that a user has selected a search result by identifying a request sent to a web site (e.g., web sites 108a-108b of FIG. 1) for a web page that corresponds to at least one of the identified search results.

If the selection identifier 204 determines that the user selected a search result (block 606), the selection identifier 204 determines whether the search result selection has been counted (block 608). If the search result selection has not already been counted (block 608), the selection identifier 204 counts a search result selection for the search engine that provided the search results (block 610). For example, when the selection identifier 204 determines that a user has selected a search result, the selection identifier 204 may increment a search result selections field (e.g., the search result selections field 406 of FIG. 4) and store the search result selection field 406 in the monitor storage 120.

After counting the search result selection (block 610), or if the search result selection has already been counted (block 608), the monitor 200 (e.g., via the example interaction timer 208 of FIG. 2) monitors the time spent at the search result (block 612). For example, the interaction timer 208 may monitor an amount of time that the web browser and/or application displaying the search result (e.g., the web browser 112) are the active window on the computer. The interaction timer 208 may further determine the average time spent on search results for the search engine and/or store the interaction time in the monitor storage 120 (e.g., in the average time at search result field 410) for the search engine 116, 118 that provided the search results. For example, the example interaction timer 208 calculates the average time spent on search results by loading a stored average time spent on search results and a number of search result selections (e.g., from the monitor storage 120), multiplying the loaded average time spent by the stored number of selections, adding the interaction time to the product and incrementing the stored number of selections, and dividing the resulting sum of the times by the incremented number of selections.

The example backtrack identifier 206 of FIG. 2 determines whether the user has backtracked to the search results (block 614). The backtrack identifier 206 may determine that a user has backtracked by, for example, monitoring user interactions with the web browser 112, such as clicking a “back” button. If the user has backtracked (block 614), the backtrack identifier 206 determines whether a time spent interacting with the user result (e.g., as determined by the example interaction timer 208 of FIG. 2) is greater than a threshold (block 616). If the time spent interacting is not greater than the threshold (block 616), the backtrack identifier 206 counts a backtrack for the search engine 116, 118 that provided the search results (block 618). For example, the backtrack identifier 206 may increment a backtrack field (e.g., the backtrack field 408 of FIG. 4) corresponding to the search engine.

After counting the backtrack for the search engine (block 618), if the time spent interacting with the search result is greater than a threshold (block 616), if the user has not backtracked (block 614), and/or if the user has not selected a search result (block 606), the search monitor 202 determines whether the user is finished with the search results (block 620). For example, the search monitor 202 may determine whether the user has navigated to another web site and/or closed the search results. If the user is not finished with the search results (block 620), control transfers to block 606 to determine whether the user has selected a search result. If the user is finished with the search results (block 620), the example instructions 600 may end or iterate for a next search.

FIG. 7 is a flowchart representative of example machine readable instructions 700 to determine search value market share. The instructions 700 may be used to implement the example system 300 of FIG. 3 to determine a search engine market share. The example instructions 700 of FIG. 7 will be described with reference to the system 300 and the table 500 of FIGS. 3 and 5.

The information collector 302 of FIG. 3 receives search data (e.g., search interaction information) from monitored users' computers (block 702). For example, the information collector 302 may receive the search data transmitted from the monitor 114 of FIG. 1 and/or similar monitors at additional computer(s) (e.g., the computer 104 of FIG. 1). The example search data may include identification(s) of search engine(s) (e.g., the search engines 116, 118) on which searches are performed, number(s) (e.g., counts) of searches on each search engine, keywords used in searches performed on each search engine, number(s) (e.g., counts) of selected search results resulting from searches performed on each search engine, number(s) (e.g., counts) of backtracks for each search engine, time(s) spent by searchers at each selected search result for each search engine, and/or average time(s) spent by searchers at selected search results for each search engines. The value calculator 304 of FIG. 3 sums the search result selections and/or the backtracks and averages the time(s) spent at the search results for each of the search engines in the search data (block 704). For example, the value calculator 304 may generate an aggregate table similar or identical in structure and/or content to the example table 400 of FIG. 4. The example value calculator 304 then sums the search result selections for each of the search engines in the search data (block 706). The sum of the search result selections is a total that is used to determine the value shares for the search engines in the search data. The example value calculator 304 also sums the backtracks for the search engines in the search data (block 708). The total backtracks may also be used to determine the value shares for the search engines in the search data.

The example instructions 700 include an example loop 710 that is performed for each of the search engines in the search data (e.g., the search engines listed in the interaction database 308). However, in some examples, the loop 710 is performed for less than all of the search engines in the search data. To perform the loop, the value calculator 304 selects a search engine from the search data and determines whether backtracks are to be excluded from the search result selections (block 712). For example, the backtracks may be excluded from the search result selections if the report is to be focused on the “useful” search results, which are defined as search results that are assumed to satisfy the user's inquiry because the user is finished with the search results after selecting a search result (and does not backtrack). In some other examples, backtracks may not be excluded to focus the report on the number of search results that interest searchers enough to select the results (e.g., facially useful search results).

If backtracks are to be excluded from search result selections (block 712), the market share determiner 306 determines the search value market share for the selected search engine to be the difference between the selections for the search engine and the backtracks for the search engine, divided by the difference between the total search result selections (as determined in block 706) and the total backtracks (as determined in block 708) (block 714). If, on the other hand, backtracks are not to be excluded from the search result selections (block 712), the market share determiner 306 determines the search value market share for the selected search engine to be the selections for the search engine divided by the total search result selections (as determined in block 706) (block 716).

After determining the search value market share (block 714 or 716), the loop 710 may iterate for another search engine and/or the market share determiner 306 may generate a market share report (block 718). For example, the market share determiner 306 may generate and/or populate a table similar or identical in structure and/or content to the table 500 of FIG. 5. In particular, the example market share determiner 306 populates a value share field 510 of FIG. 5 to provide the search value market share to users of the report. In some examples, the market share report further includes other types of search engine market share, such as search volume market share. After generating the report (block 718), the example instructions 700 may end and/or iterate to generate another market share report.

FIG. 8 is a block diagram of an example computer 800 capable of executing the instructions 600, 700 of FIGS. 6 and 7 to implement the monitor 200 of FIG. 2, the system 300 of FIG. 3, and/or the system of FIG. 1. The computer 800 can be, for example, a server, a personal computer, a mobile phone (e.g., a cell phone), a personal digital assistant (PDA), an Internet appliance, a set top box, or any other type of computing device.

The computer 800 of the instant example includes a processor 812. For example, the processor 812 can be implemented by one or more Intel® microprocessors from the Pentium® family, the Itanium® family or the XScale® family. Of course, other processors from other families are also appropriate.

The processor 812 is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 816 may be implemented by flash memory and/or any other desired type of memory device. Access to the main memory 814, 816 is controlled by a memory controller.

The computer 800 also includes an interface circuit 820. The interface circuit 820 may be implemented by any type of interface standard, such as an Ethernet interface, a universal serial bus (USB), and/or a PCI express interface.

One or more input devices 822 are connected to the interface circuit 820. The input device(s) 822 permit a user to enter data and commands into the processor 812. The input device(s) can be implemented by, for example, a keyboard, a mouse, a touchscreen, a track-pad, a trackball, isopoint and/or a voice recognition system.

One or more output devices 824 are also connected to the interface circuit 820. The output devices 824 can be implemented, for example, by display devices (e.g., a liquid crystal display, a cathode ray tube display (CRT), a printer and/or speakers). The interface circuit 820, thus, typically includes a graphics driver card.

The interface circuit 820 also includes a communication device such as a modem or network interface card to facilitate exchange of data with external computers via a network 826 (e.g., an Ethernet connection, a digital subscriber line (DSL), a telephone line, coaxial cable, a cellular telephone system, etc.).

The computer 800 also includes one or more mass storage devices 828 for storing software and data. Examples of such mass storage devices 828 include floppy disk drives, hard drive disks, compact disk drives and digital versatile disk (DVD) drives. The mass storage device 828 may implement the monitor storage 120 and/or the interaction database 310. In some examples, the mass storage device 828 is implemented using arrays of storage devices arranged in, for example, a redundant array of independent disks (RAID) configuration.

The coded instructions 600, 700 of FIGS. 6 and 7 may be stored in the mass storage device 828, in the volatile memory 814, in the non-volatile memory 816, and/or on a removable storage medium 324 such as a CD or DVD.

Example methods, apparatus and articles of manufacture have been disclosed to collect search engine data and/or determine search engine market share in an advantageous manner. In particular, disclosed methods, apparatus, and articles of manufacture provide a measure of value provided to searchers by available search engines. This measure of value may be used by advertisers to decide on which search engines to advertise, by investors to determine which search engine companies are attractive investments, and/or by search engine operators to learn how to improve their respective search engines and/or how much to charge advertisers. The example search value market share metric disclosed herein may be used in combination with other methods, apparatus, and/or articles of manufacture to report search engine market share and/or to provide a robust set of search engine market share data. Additionally, example methods, apparatus, and/or articles of manufacture disclosed herein are less susceptible to manipulation by persons associated with the search engines who would like to inflate or deflate a search engine's market share. This reduction in ease of manipulation is achieved, for example, by implementing the example system by a neutral entity such as The Nielsen Company.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method, comprising:
determining a first number of search results that were selected by a user and a second number of search results that were selected by the user, wherein the first number of search results is associated with searches performed via a first search engine and the second number of search results is associated with searches performed via a second search engine; and
determining a first market share for the first search engine based on the first number and the second number of search results selected by the user.

2. A method as defined in claim 1, further comprising determining the first number of selected search results for the first search engine based on a plurality of hypertext transfer protocol messages.

3. A method as defined in claim 2, wherein determining the first market share comprises:
determining a third number of search results selected by a plurality of users, wherein the third number of search results is associated with searches performed via the first search engine and includes the first number;
determining a total number of search results selected by the plurality of users by summing the third and second numbers; and
determining the first market share by dividing the third number of selected search results by the total number of selected search results.

4. A method as defined in claim 3, further comprising:
determining a fourth number of search results selected by the plurality of users, wherein the fourth number of search results is associated with searches performed via the second search engine and includes the second number; and
determining a second market share by dividing the fourth number of selected search results by the total number of search results.

5. A method as defined in claim 2, further comprising identifying a backtrack based on a user interaction with a search result.

6. A method as defined in claim 5, wherein determining the backtrack comprises measuring an interaction time with a search result and comparing the interaction time with a threshold, and identifying the backtrack when the interaction time is less than a threshold.

7. A method as defined in claim 5, wherein determining the first market share comprises subtracting a number of backtracks from the third number.

8. A system to determine a search engine market share, comprising:
an information collector to receive search information for search results;
a value calculator to determine a value of the search results based on the search information; and
a market share determiner to determine the market share of the search engine based on the value.

9. A system as defined in claim 8, further comprising a database to store at least one of the search interaction information, the value of the search results, or the market share.

10. A system as defined in claim 8, wherein the value calculator is to determine the value based on a number of search result selections by users from search results provided by the search engine.

11. A system as defined in claim 8, wherein the market share determiner is to:
determine a first number of search results selected by a plurality of users, wherein the first number of selected search results is associated with searches performed via the search engine;
determine a total number of search results selected by the plurality of users; and
determine the market share for the search engine by dividing the first number of selected search results by the total number of search results.

12. A system as defined in claim 11, wherein the market share calculator is to reduce the first number of selected search results by a first number of backtracks corresponding to the search engine, and reduce the total number of selected search results by a total number of backtracks.

13. A system as defined in claim 12, wherein a backtrack is identified based on an interaction time with a selected search result prior to the backtrack.

14. A system as defined in claim 8, wherein the market share determiner is to generate a report of the market share.

15. A tangible article of manufacture comprising machine readable instructions which, when executed, cause a machine to at least:
receive a first number of search results and a second number of search results that were selected by a user, the first number of search results being associated with searches performed via a first search engine and the second number of search results being associated with searches performed via a second search engine; and
determine a market share for the first search engine based on the first number and the second number of search results selected by the user.

16. An article of manufacture as defined in claim 15, wherein the instructions cause the machine to at least determine the first number of selected search results for the first search engine based on a plurality of hypertext transfer protocol messages.

17. An article of manufacture as defined in claim 16, wherein determining the market share comprises:
determining a third number of search results selected by a plurality of users, wherein the third number of search results is associated with searches performed via the first search engine and includes the first number;
determining a total number of search results selected by the plurality of users by summing the third and second numbers; and
determining the first market share by dividing the third number of selected search results by the total number of selected search results.

18. An article of manufacture as defined in claim 16, wherein the instructions cause the machine to identify a backtrack based on a user interaction with a search result.

19. An article of manufacture as defined in claim 18, wherein determining the backtrack comprises measuring an interaction time with a search result and comparing the interaction time with a threshold, and identifying the backtrack when the interaction time is less than a threshold.

20. An article of manufacture as defined in claim 18, wherein determining the first market share comprises subtracting a number of backtracks from the third number.
